(19) United States
(12) Patent Application Publication
(10) Pub. No.: US 2023/0079456 A1
(43) Pub. Date: Mar. 16, 2023

(54) Brushless Motor

(71) Applicant: SHENZHEN TOPBAND CO., LTD., Shenzhen (CN)

(72) Inventors: Xingwei WANG, Shenzhen (CN); Yong BU, Shenzhen (CN)

(73) Assignee: SHENZHEN TOPBAND CO., LTD., Shenzhen (CN)

(21) Appl. No.: 17/795,877

(22) PCT Filed: May 19, 2020
(86) PCT No.: PCT/CN2020/091107

§ 371 Date: Jul. 28, 2022

(30) Foreign Application Priority Data
Mar. 10, 2020 (CN) 202020285278.9

(51) Int. Cl. H02K 1/2791; H02K 5/173; H02K 7/00; H02K 7/08; H02K 9/06; H02K 11/215; H02K 21/22

(52) U.S. Cl. CPC H02K 1/2791; H02K 5/1735; H02K 7/003; H02K 7/085; H02K 9/06; H02K 11/215; H02K 21/22; H02K 2211/03

(57) ABSTRACT

A brushless motor includes a stator assembly and a rotor assembly one coaxially disposed around the other. The rotor assembly includes a spindle and a rotor yoke coaxially disposed around the spindle. At least two magnet receiving grooves for receiving magnets are formed in an inner wall of the rotor yoke in a circumferential direction, the magnets are inserted into the magnet receiving grooves, and a magnetism isolating gap is formed between the at least two magnet receiving grooves. Through the external-rotor design, the size and weight of the motor are effectively reduced, the working efficiency of the motor is effectively improved under the same power, the life of a lithium battery is further prolonged, the energy conversion requirement is met, and user experience is improved.

### FIELD

The invention relates to the technical field of motors, in particular to a brushless motor.

### BACKGROUND

With the ever wider application of clean energy, lithium battery power heads will eventually be applied to garden machines and completely replace gasoline engines commonly existing on the present market. Motors used in the lithium battery power heads commonly existing on the present market use internal-rotor brushless motors and brush DC motors, which have the drawbacks of high cost caused by a large size, low market competitiveness, low efficiency, and failure to meet current energy conservation requirements.

### SUMMARY

The technical issue to be settled by the invention is to provide a brushless motor to overcome the defects of the prior art.

The technical solution adopted by the invention to settle the above technical issue is as follows:

A brushless motor comprises a stator assembly and a rotor assembly one coaxially disposed around the other. The rotor assembly comprises a spindle and a rotor yoke coaxially disposed around the spindle. At least two magnet receiving grooves for receiving magnets are formed in an inner wall of the rotor yoke in a circumferential direction, the magnets are inserted into the magnet receiving grooves, and a magnetism isolating gap is formed between the at least two magnet receiving grooves.

Preferably, the rotor assembly further comprises a housing coaxially disposed around an end of the spindle, a fixing key for preventing the spindle and the housing from moving relative to each other is disposed between the spindle and the housing, the spindle is provided with a first key groove for receiving the fixing key, and the housing is provided with a second key groove for receiving the fixing key.

Preferably, at least one grating for heat dissipation is disposed at an end, away from the rotor yoke, of the housing.

Preferably, the rotor yoke is coaxially sleeved in the housing, at least one first convex portion and at least one first concave portion are alternately disposed on an outer wall of the rotor yoke in a circumferential direction, and second concave portion and second convex portion, which correspond to the first convex portion and the first concave portion in number and shape respectively, are alternately disposed on an inner wall of the housing in the circumferential direction, the second concave portion being engaged with the first convex portion, the second convex portions being engaged with the first concave portion.

Preferably, the spindle at least comprises a first cylinder section connected to the housing, a second cylinder section with a diameter greater than that of the first cylinder section, and a third cylinder section with a diameter smaller than that of the second cylinder section, the first cylinder section, the second cylinder section and the third cylinder section being arranged coaxially, and the first cylinder section and the third cylinder section being disposed on two sides of the second cylinder section respectively.

Preferably, the brushless motor further comprises a first bearing and a second bearing configured for guiding the spindle to rotate with respect to the stator assembly, the first bearing is coaxially disposed around the first cylinder, and the second bearing is coaxially disposed around the third cylinder.

Preferably, the first bearing is fixedly arranged between the fixing key and the second cylinder section, a first retainer ring for limiting the second bearing is disposed around the third cylinder, and the second bearing is fixedly arranged between the first retainer ring and the second cylinder,

a first retainer ring groove for fixing the first retainer ring is formed in the third cylinder section.

Preferably, the stator assembly comprises a stator holder and an armature assembly which are coaxial with the spindle, and the stator holder comprises a mounting portion for fixing the brushless motor and a protruding portion coaxially sleeved in an inner wall of the rotor yoke.

Preferably, the armature assembly comprises at least two stator armatures disposed between the magnets and the protruding portion, and Hall PCBs respectively electrically connected to the stator armatures, and at least one winding bracket for winding an enameled wire thereon is disposed at each of two ends of the stator armature.

Preferably, a bearing chamber for receiving the second bearing is disposed in the stator holder, a second retainer ring groove for mounting a second retainer ring is formed in the bearing chamber, and the second retainer ring cooperates with the first retainer ring to fix the second bearing.

The invention has the following beneficial effects: through the external-rotor design, the size and weight of the motor are effectively reduced, the working efficiency of the motor is effectively improved under the same power, the life of a lithium battery is further prolonged, the energy conversion requirement is met, and user experience is better.

### BRIEF DESCRIPTION OF THE DRAWINGS

The invention will be further described below in conjunction with accompanying drawings and embodiments. In the figures:

FIG. 1 is a structural view of a brushless motor according to an embodiment of the invention;

FIG. 2 is a sectional view of the brushless motor according to an embodiment of the invention;

FIG. 3 is a sectional view of a stator holder according to the invention;

FIG. 4 is an exploded view of a rotor assembly according to the invention;

FIG. 5 is an enlarged view of part A in the exploded view of the rotor assembly shown in FIG. 4;

FIG. 6 is a schematic diagram of a housing according to the invention;

FIG. 7 is a schematic diagram of a spindle according to the invention.

### DESCRIPTION OF THE EMBODIMENTS

To gain a better understanding of the technical features, purposes and effects of the invention, specific implementations of the invention will be described in detail below with reference to the accompanying drawings.

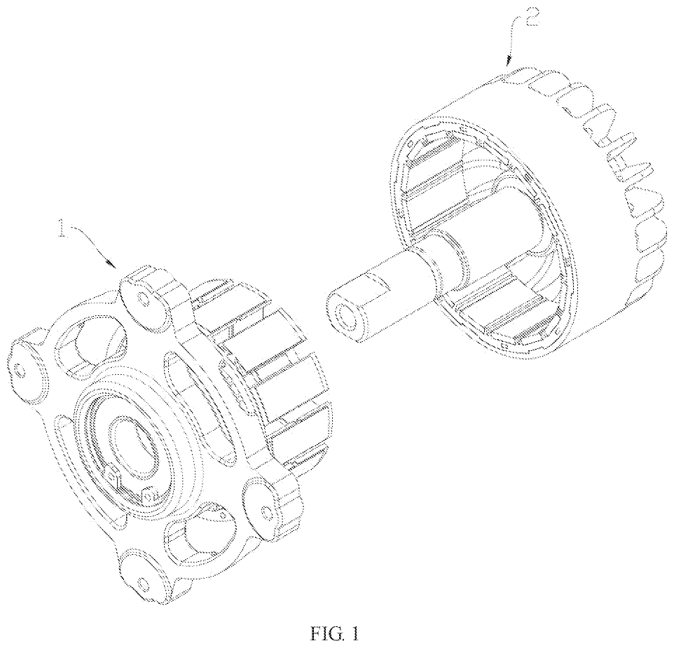

FIG. 1 illustrates a brushless motor according to some embodiments of the invention, and the brushless motor may be applied to garden machinery and equipment or be used as power suppliers in other fields. The brushless motor may comprise a stator assembly 1 and a rotor assembly 2 arranged with one sleeved around the other coaxially, and after being powered on, the stator assembly 1 generates a magnetic field which interacts with a magnetic field in the rotor assembly 2 to make the motor start to work.

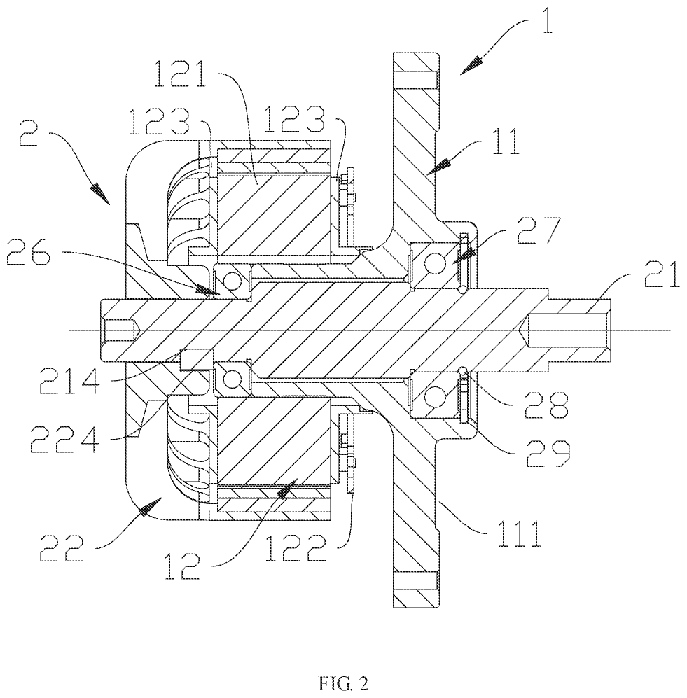

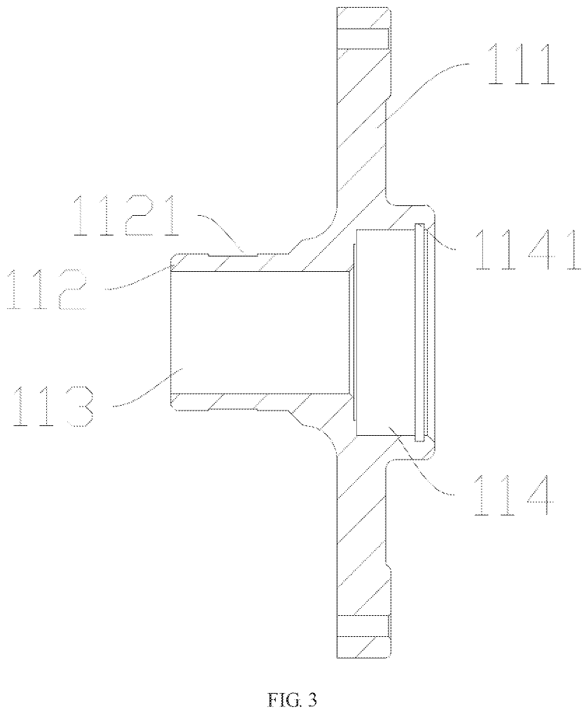

As shown in FIG. 2, the stator assembly 1 may comprise a stator holder 11 configured for fixedly connecting the brushless motor to an external machine, and an armature assembly 12 which, after being powered on, generates a magnetic field and a force interacting with the rotor assembly 2. In some embodiments, the stator holder 11 is made of a metal material, preferably 45 # steel. As shown in FIG. 3 which illustrates the stator holder 11 according to some embodiments of the invention, the stator holder 11 may comprise a mounting portion 111 fixedly connected to the external machine and a protruding portion 112 fixedly connected to the armature assembly 12. In some embodiments, the stator holder 11 is fixedly connected to the external machine through screws, and a plurality of screw holes allowing the screws to penetrate through are formed in the mounting portion 111. In other embodiments, the stator holder 11 may be fixedly connected to the external machine in other manners such as a clamped manner, a welded manner or a riveted manner. In some embodiments, the mounting portion 111 is approximately square and is configured for fixed connection. It can be understood that the shape, size and structure of the mounting portion 111 may be adjusted as actually needed. For example, the mounting portion 111 may be circular or in other shapes. The protruding portion 112 extends from one surface of the mounting portion 111 in a direction away from the mounting portion 111 and has a cylindrical shape. In some embodiments, the protruding portion 112 is perpendicular to the mounting portion 111, and the section of the stator holder 11 is T-shaped. Further, the stator holder 11 is provided with a first through hole 113 penetrating through the mounting portion 111 and the protruding portion 112, and configured to match and mount the rotor assembly 2 therein. In some embodiments, an annular glue trough 1121 may be disposed on an outer wall of the protruding portion 112, and the glue trough 1121 has a diameter smaller than that of the protruding portion 112 and is configured for filling and retaining glue therein. As shown in FIG. 2, the armature assembly 12 comprises at least two stator armatures 121 disposed on the outer wall of the protruding portion 112 and Hall PCBs 122 respectively electrically connected to the stator armatures 121, characterized in that the number of the stator armatures 121 is at least two, glue is filled in the glue trough 1121 to fixedly connect the stator armatures 121 and the stator holder 11, and a plurality of stator armatures 121 may be uniformly distributed around the outer wall of the protruding portion 112. At least one winding bracket 123 for winding an enameled wire thereon is disposed at each of two ends of the stator armature 121. In some embodiments, the at least one winding bracket 123 is fixedly connected to the stator holder 11 by welding. In some other embodiments, the at least one winding bracket 123 may be fixedly connected to the stator holder 11 by riveting or in other manners.

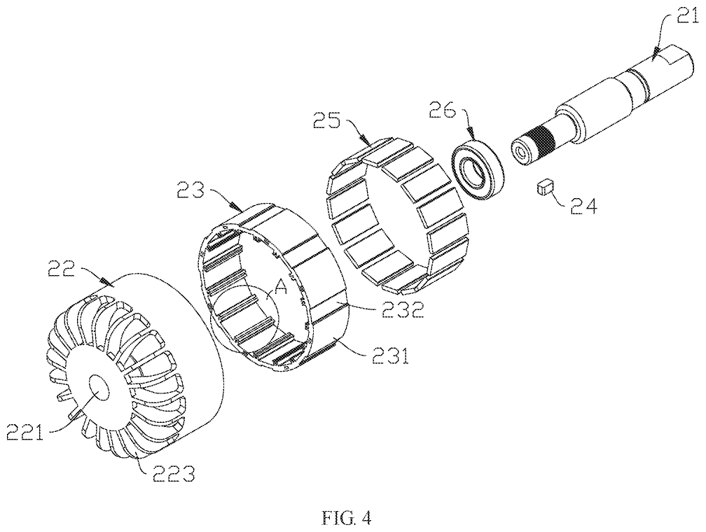

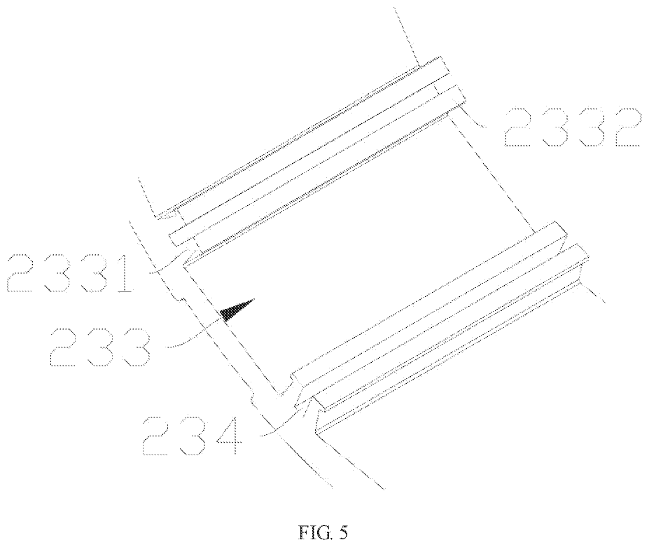

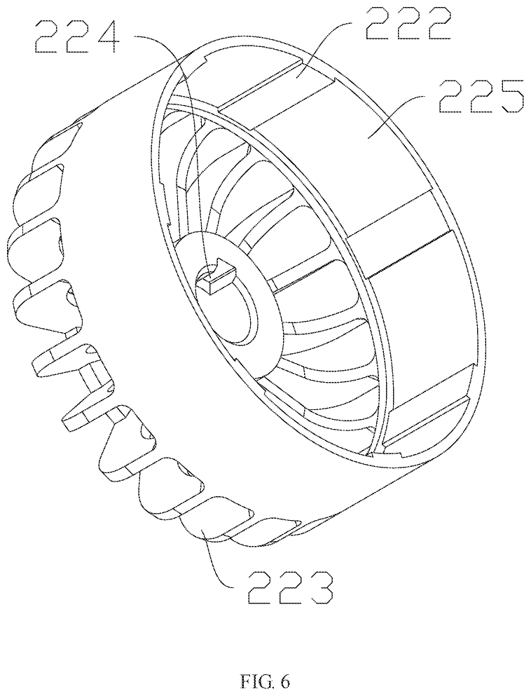

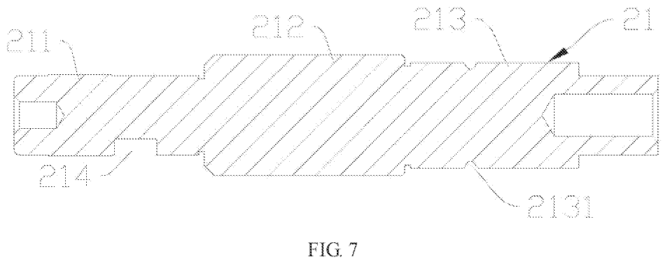

FIG. 4 illustrates the rotor assembly 2 according to some embodiments of the invention. The rotor assembly 2 comprises a spindle 21, and a housing 22 and a rotor yoke 23 which are coaxially disposed around the spindle 21, characterized in that the spindle 21 is preferably a cylindrical spindle made of steel. As shown in FIG. 2, the spindle 21 horizontally penetrates through the stator holder 11 via the first through hole 113; and further, the first through hole 113 matches an outer wall of the spindle 21 in shape. Referring to FIG. 5, in some embodiments, the housing 22 is shaped like a cup with an opening facing the stator holder 11, a second through hole 221 allowing the spindle 21 to penetrate through is formed in the bottom of the cup-shaped housing 22, and preferably, the opening of the cup-shaped housing 22 faces the protruding portion 112 of the stator holder 11; and the housing 22 and the stator holder 11 are arranged coaxially, the protruding portion 112 is partially received in the housing 22, and the spindle 21 penetrates through the stator holder 11 and the housing 22 through the first through hole 113 and the second through hole 221. In some embodiments, the housing 22 is preferably made of aluminum alloy through die-casting. Referring to FIG. 4, the cup-shaped bottom of the housing 22 is in a grating shape and is provided with at least one grating 223. Preferably, a plurality of gratings 223 are uniformly arranged at the bottom of cup-shaped housing 22 in a circumferential direction, and the gratings 223 may be used as cooling blades to provide a good cooling effect for the motor; and the housing made of the aluminum alloy can reduce the size and weight of the motor and increase the power density and torque density of the motor. In some embodiments, the spindle 21 and the housing 22 are fixed through a fixing key 24, and a first key groove 214 and a second key groove 224 for receiving the fixing key 24 are formed in corresponding positions of the spindle 21 and the housing 22 respectively. Through key connection, the axial pull-off strength and the radial pull-off strength of the housing 22 can be improved to ensure that the housing 22 will not come loose or move relative to the spindle 21 under a large toque and a high speed, thus maintaining high reliability of the motor. In some embodiments, the second key groove 224 preferably protrudes out of an inner wall of the second through hole 221. In some embodiments, the rotor yoke 23 is formed by silicon steel sheets that are stacked together, is preferably cylindrical-shaped; and is coaxially covered with the housing 22. Referring to FIG. 4 and FIG. 6, at least one first convex portion 231 and at least one first concave portion 232 are alternately disposed on an outer wall of the rotor yoke 23 in a circumferential direction, at least one second concave portion 225 and at least one second convex portion 222, which correspond to the first convex portions 231 and the first concave portions 232 in number and shape, are disposed on an inner wall of the housing 22 in a circumferential direction at intervals. The first convex portions 231 are engaged with the second concave portions 225, and the first concave portions 232 are engaged with the second convex portions 222, so that the rotor yoke 23 and the housing 22 rotate synchronously. As shown in FIG. 4 and FIG. 5, a plurality of magnet receiving grooves 233 for receiving magnets 25 are formed in an inner wall of the rotor yoke 23. In some embodiments, each magnet receiving groove 233 comprises side walls 2331 for receiving the magnet 25 and a stop wall 2332 for preventing the magnet 25 from falling off in a radial direction, and the magnets 25 are inserted into the magnet receiving grooves 233. In some embodiments, magnetism isolating gaps 234 are formed between the side walls 2331 of the adjacent magnet receiving grooves 233, so that the multiple magnets 25 are prevented from being too close to each other, which may otherwise affect the magnetism of the magnets 25. In some embodiments, the magnets 25 are permanent magnets which interact with a magnetic field generated after the stator armatures 121 are powered on, so that the magnets 25 are driven to rotate with respect to the stator armatures 121. Characterized in that, the number of the magnets 25 is at least two. Preferably, a plurality of magnets 25 are regularly distributed on the inner wall of the rotor yoke 23 in the circumferential direction; and the number of the magnet receiving grooves 233 is the same as that of the magnets 25. In some embodiments, besides the magnets 25 are stopped by the stop walls 2332 from moving in a radial direction, the magnets 25 are connected to the magnet receiving grooves 233 with glue, thus being prevented from moving in the radial direction with respect to the magnet receiving grooves 233. As shown in FIG. 2, the rotor assembly 2 further comprises a first bearing 26 and a second bearing 27, which are coaxially disposed on the spindle 21 and are configured for guiding the spindle 21 to rotate with respect to the stator assembly 1. Referring to FIG. 7, in some embodiments, the spindle 21 comprises at least three cylinder sections, of which the diameters are not completely identical, characterized in that the diameter of a first cylinder section 211 and the diameter of a third cylinder section 213 are smaller than the diameter of a second cylinder section 212, the first cylinder section 211 and the third cylinder section 213 are located at opposite two ends of the second cylinder section 212 respectively, and the first cylinder section 211, the second cylinder section 212 and the third cylinder section 213 are arranged coaxially. It can be understood that the diameter of the first cylinder section 211 and the diameter of the third cylinder section 213 are not specified, and may be identical or different. The first bearing 26 is disposed around the first cylinder section 211, and the second bearing 27 is disposed around the third cylinder section 213. In some embodiments, the diameter of the first cylinder section 211 is different from the diameter of the second cylinder section 212 and the diameter of the third cylinder section 213 is different from the diameter of the second cylinder section 212, so that two steps having an obvious fall therebetween are formed. The first bearing 26 is coaxially disposed around the first cylinder section 211, one end face of the first bearing 26 is closely attached to the end face of the step formed by the first cylinder section 211 and the adjacent second cylinder section 212, and the fixing key 24 is disposed closely to the other end face of the first bearing 26 and is configured for limiting the first bearing 26 and preventing the first bearing 26 from moving with respect to the spindle 21 during high-speed rotation. One end face of the second bearing 27 is closely attached to the end face of the step formed by the third cylinder section 213 and the adjacent second cylinder section 212, the second bearing 27 is limited by a first retainer ring 28 disposed around the third cylinder section 213, and further, a first retainer ring groove 2131 for receiving and fixing the first retainer ring 28 is formed in the third cylinder section 213. In some embodiments, the first retainer ring groove 2131 is an annular groove. Further, a bearing chamber 114 for receiving the second bearing 27 is disposed in the stator holder 11, a second retainer ring 29 for further limiting the second bearing 27 is disposed in the bearing chamber 114, a second retainer ring groove 1141 for accommodating the second retainer ring 29 is formed in the bearing chamber 114 and is located at an end, away from the protruding portion 111, of the bearing chamber 114. The first retainer ring 28 and the second retainer ring 29 can effectively prevent the rotor assembly from falling as a whole during high-speed operation, the assembly structure of the motor is simple, and the labor costs are greatly reduced.

The above embodiments are specifically described in detail to express several implementations of the invention, and should not be construed as limitations of the scope of the patent of invention. It should be noted that those ordinarily skilled in the art may make some transformations and improvements without departing from the concept of the invention, and all these transformations and improvements should fall within the protection scope of the invention. Therefore, the protection scope of the patent of invention should be defined by the appended claims.

1. A brushless motor, comprising a stator assembly (1) and a rotor assembly (2) arranged with one sleeved around the other coaxially, wherein the rotor assembly (2) comprises a spindle (21) and a rotor yoke (23) coaxially disposed around the spindle (21), at least two magnet receiving grooves (233) for receiving magnets (25) are formed in an inner wall of the rotor yoke (23) in a circumferential direction, the magnets (25) are inserted into the at least two magnet receiving grooves (233), and a magnetism isolating gap (234) is formed between the at least two magnet receiving grooves (233).

2. The brushless motor according to claim 1, wherein the rotor assembly (2) further comprises a housing (22) coaxially disposed around an end of the spindle (21), a fixing key (24) for preventing the spindle (21) and the housing (22) from moving relative to each other is disposed between the spindle (21) and the housing (22), the spindle (21) is provided with a first key groove (214) for receiving the fixing key (24), and the housing (22) is provided with a second key groove (224) for receiving the fixing key (24).

3. The brushless motor according to claim 2, wherein at least one grating (223) for heat dissipation is disposed at an end, away from the rotor yoke (23), of the housing (22).

4. The brushless motor according to claim 2, wherein the rotor yoke (23) is coaxially sleeved in the housing (22), at least one first convex portion (231) and at least one first concave portion (232) are alternately disposed on an outer wall of the rotor yoke (23) in a circumferential direction, and second concave portion (225) and second convex portion (222), which correspond to the first convex portion (231) and the first concave portion (232) in number and shape respectively, are alternately disposed on an inner wall of the housing (22) in the circumferential direction, the second concave portion (225) being engaged with the first convex portion (231), the second convex portions (222) being engaged with the first concave portion (232).

5. The brushless motor according to claim 2, wherein the spindle (21) at least comprises a first cylinder section (211) connected to the housing (22), a second cylinder section (212) with a diameter greater than that of the first cylinder section (211), and a third cylinder section (213) with a diameter smaller than that of the second cylinder section (212), the first cylinder section (211), the second cylinder section (212) and the third cylinder section (213) being arranged coaxially, and the first cylinder section (211) and the third cylinder section (213) being disposed on two ends of the second cylinder section (212) respectively.

6. The brushless motor according to claim 5, further comprising a first bearing (26) and a second bearing (27) configured for guiding the spindle (21) to rotate with respect to the stator assembly (1), the first bearing (26) is coaxially disposed around the first cylinder (211), and the second bearing (27) is coaxially disposed around the third cylinder (213).

7. The brushless motor according to claim 6, wherein the first bearing (26) is fixedly arranged between the fixing key (24) and the second cylinder section (212), a first retainer ring (28) for limiting the second bearing (27) is disposed around the third cylinder (213), and the second bearing (27) is fixedly arranged between the first retainer ring (28) and the second cylinder (212); and
a first retainer ring groove (2131) for fixing the first retainer ring (28) is formed in the third cylinder section (213).

8. The brushless motor according to claim 7, wherein the stator assembly (1) comprises a stator holder (11) and an armature assembly (12) which are coaxial with the spindle (21), and the stator holder (11) comprises a mounting portion (111) for fixing the brushless motor and a protruding portion (112) coaxially sleeved in an inner wall of the rotor yoke (23).

9. The brushless motor according to claim 8, wherein the armature assembly (12) comprises at least two stator armatures (121) disposed between the magnets (25) and the protruding portion (112), and Hall PCBs (122) respectively electrically connected to the stator armatures (121), and at least one winding bracket (123) for winding an enameled wire thereon is disposed at each of two ends of the stator armature (121).

10. The brushless motor according to claim 8, wherein a bearing chamber (114) for receiving the second bearing (27) is disposed in the stator holder (11), a second retainer ring groove (1141) for mounting a second retainer ring (29) is formed in the bearing chamber (114), and the second retainer ring (29) cooperates with the first retainer ring (28) to fix the second bearing (27).
